(19) United States
(12) Patent Application Publication
(10) Pub. No.: US 2019/0378189 A1
(43) Pub. Date: Dec. 12, 2019

(54) SYSTEM AND METHOD FOR CREATING CUSTOMIZED GARMENTS

(71) Applicant: Peigen Jiang, Sammamish, WA (US)

(72) Inventor: Peigen Jiang, Sammamish, WA (US)

(21) Appl. No.: 16/004,402

(22) Filed: Jun. 10, 2018

(51) Int. Cl. G06Q 30/06

(52) U.S. Cl. CPC G06Q 30/0621; G06F 17/30312

(57) ABSTRACT

A computer-implemented system and method for creating customized garments are disclosed which include executing on a processor in a central server the steps of generating a first cut pattern upon receiving a first electronic communication from a first remote computer identifying a first garment design using a first fabric, generating a second cut pattern upon receiving a second electronic communication from a second remote computer identifying a second garment design also using the first fabric, identifying a supplier of the first fabric by searching in a fabric database using a code of the first fabric, and sending electronic communications containing the first and the second cut pattern to a third remote computer relating to the identified supplier of the first fabric.

### BACKGROUND

The present disclosure relates generally to the field of garment selection and production, and, more particularly, to a system and method for creating customized garments for individual customers.

Conventionally, a person can acquire customized garments by going to a tailor to have body measurements and to inform his or her personal taste. Then the tailor designs and sews garments specifically for the person. However, the customer usually can access only one tailor at a time; and the tailor can only server one customer at time as well. In addition, a tailor's design style may not be a match to a customer's taste, thus a visit by the customer to the tailor will not yield satisfying result. As such what is needed is a system and method that facilitates a customer to access numerous design and manufacturing resources for acquiring customized garments.

### SUMMARY

A computer-implemented system and method for creating customized garments are disclosed which include executing on a processor in a central server the steps of generating a first cut pattern upon receiving a first electronic communication from a first remote computer identifying a first garment design using a first fabric, generating a second cut pattern upon receiving a second electronic communication from a second remote computer identifying a second garment design also using the first fabric, identifying a supplier of the first fabric by searching in a fabric database using a code of the first fabric, and sending electronic communications containing the first and the second cut pattern to a third remote computer relating to the identified supplier of the first fabric.

### BRIEF DESCRIPTION OF THE DRAWING

FIG. 1 illustrates a system for creating customized garments according to embodiments of the present disclosure.

FIG. 2 illustrates a consumer's terminal according to an embodiment of the present disclosure.

FIG. 3 illustrates an exemplary designer's terminal according to an embodiment of the present disclosure.

FIG. 4 illustrates an exemplary fabric supplier's terminal according to an embodiment of the present disclosure.

FIG. 5 illustrates an exemplary central server according to an embodiment of the present disclosure.

FIG. 6 is a flowchart illustrating a garment ordering process according to an embodiment of the present disclosure.

FIG. 7 is a flowchart illustrating an order processing procedure according to an embodiment of the present disclosure.

The drawings accompanying and forming part of this specification are included to depict certain aspects of the disclosure. A clearer conception of the disclosure, and of the components and operation of systems provided with the disclosure, will become more readily apparent by referring to the exemplary, and therefore non-limiting, embodiments illustrated in the drawings, wherein like reference numbers (if they occur in more than one view) designate the same elements. The disclosure may be better understood by reference to one or more of these drawings in combination with the description presented herein.

### DESCRIPTION

The present disclosure relates to a system and method for creating customized garments. A preferred embodiment of the present disclosure will be described hereinafter with reference to the attached drawings.

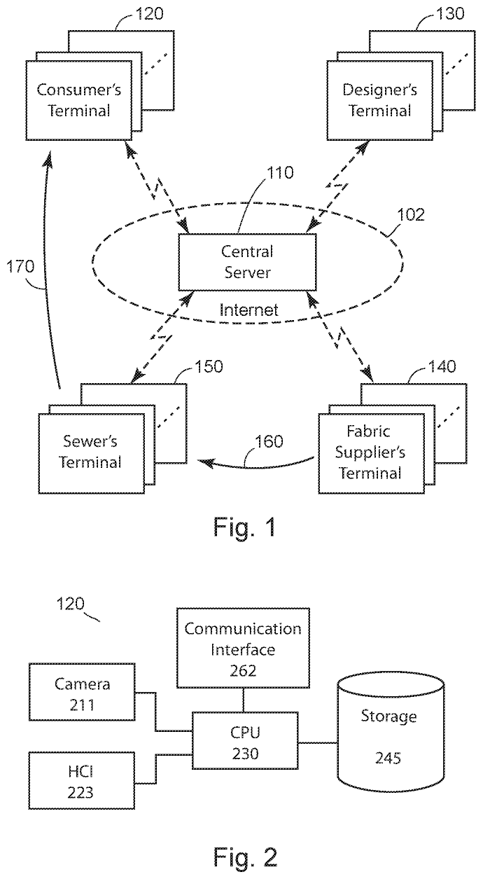

FIG. 1 illustrates a system for creating customized garments according to embodiments of the present disclosure. The system is based on the Internet 102 in which a central server 110 is connected to. A customized garment creation application (CGCA) runs on the central server 110 with a Uniform Resource Locator (URL). A plurality of consumer's terminals 120 are separately connected to the central server 110 through the Internet 102. Similarly, a plurality of designer's terminals 130, a plurality of fabric supplier's terminals 140 and a plurality of sewer's terminals 150 are separately connected to the central server 110 through the Internet 102. The various terminals 120, 130, 140 and 150 may be computers with a browser to access the Internet. When the URL is entered in the browser, the CGCA can be accessed from the various remote terminal computers.

In operation, the central server 110 receives garment and fabric designs from the plurality of the designer's terminals 130. The central server 110 makes the garment designs available for searching and browsing by the plurality of consumer's terminals 120, and the fabric designs available for searching and browsing by the plurality of fabric supplier's terminals 140. In addition, the central server 110 receives fabric information from the plurality of fabric supplier's terminals 140 which are then made available to the plurality of designer's terminal 130 for being used in garment designs. Once a consumer's terminal 120 enters a garment design selection, the central server 110 generates fabric patterns corresponding to the selected garment design and then sends the fabric patterns to a corresponding fabric supplier's terminal for fabric cutting. The central server 110 also informs the corresponding fabric supplier's terminal 140 to send the cut fabric to a particular sewer's terminal 150 as shown by an arrow 160 for sewing the cut fabric into a garment according to the garment design. Once the sewing is done, the sewer sends the garment to this particular consumer's terminal 120 as shown by an arrow 170.

FIG. 2 illustrates an exemplary consumer's terminal 120 according to an embodiment of the present disclosure. The consumer's terminal 120 includes a camera 211, a human-computer interface (HCI) 223, a central processing unit (CPU) 230, a storage 245 and a communication interface 262. The camera 211 may be used to take pictures of a user for obtaining body measurements thereof. The user's pictures may be taken from multiple direction, such as front, rear and sides with dimensional references to generate a three-dimensional body measurement. Alternatively, the body measurements can be measured manually and entered by the user through the HCI 223, which may include a keyboard, a mouse and a display. Through the HCI 223, the user can view garment designs, enter his or her taste information and make selection through a web browser run by the CPU 230. The web browser communicates with CGCA run on the central server 110 through the communication interface 262, which may include a wi-fi router and a cable modem. The communication between the consumer's terminal 120 and the central server 110 may include receiving the garment designs from the central server 110 and sending the body measurements, taste information and user selections to the central server 110. The aforementioned information may be stored in the storage 245.

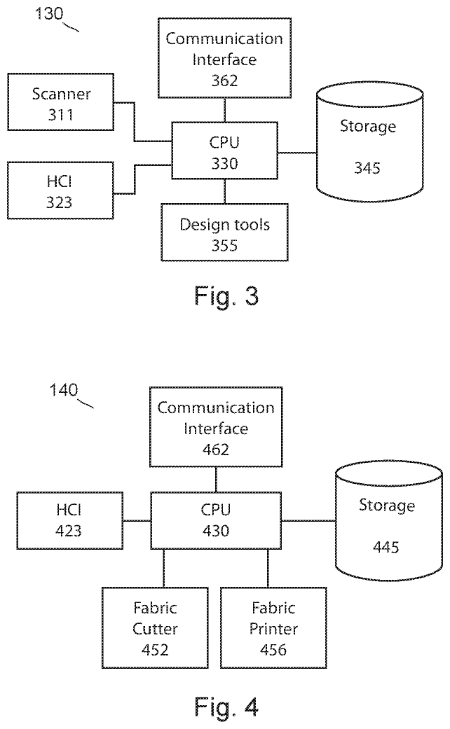

FIG. 3 illustrates an exemplary designer's terminal 130 according to an embodiment of the present disclosure. The designer's terminal 130 includes a scanner 311, an HCI 323, a CPU 330, a storage 345, software design tools 355 and a communication interface 362. The scanner 311 may be used to scan in fabric or garment designs created on a physical medium such as paper. A designer may also create fabric or garment designs digitally using the software design tools 355 through HCI 323 which may include a keyboard, a mouse, a drawing tablet and a display. The software design tools 355 run on the CPU 330 and the storage 345. The designer then submits the fabric and/or garment designs to the central server 110 in proper categories via the communication interface 360 over the Internet. The communication interface 360 may include a Wi-Fi router and a modem. In embodiments, the designer's terminal 130 also generates fabric patterns for its own designs for certain body measurements when orders come in, and then sends the fabric patterns to the fabric supplier's terminal 140 for printing and/or cutting.

FIG. 4 illustrates an exemplary fabric supplier's terminal 140 according to an embodiment of the present disclosure. The fabric supplier's terminal 140 includes an HCI 423, a CPU 430, a storage 445, a fabric cutter 452, a fabric printer 456 and a communication interface 362. A fabric supplier may operate the fabric supplier's terminal 140 through the HCI 423 which may include a keyboard, a mouse and a display. The CPU 430 and the storage 445 run a web browser for communicating with the CGCA run on the central server 110 through the communication interface 462. The fabric supplier's terminal 140 sends its fabric inventory information to the central server 110, and in return receives fabric cutting patterns to be cut by the fabric cutter 452 and fabric designs to be printed by the fabric printer 456 from the central server 110. The cut fabric is then sent to a sewer's terminal 150 designated by the central server 110.

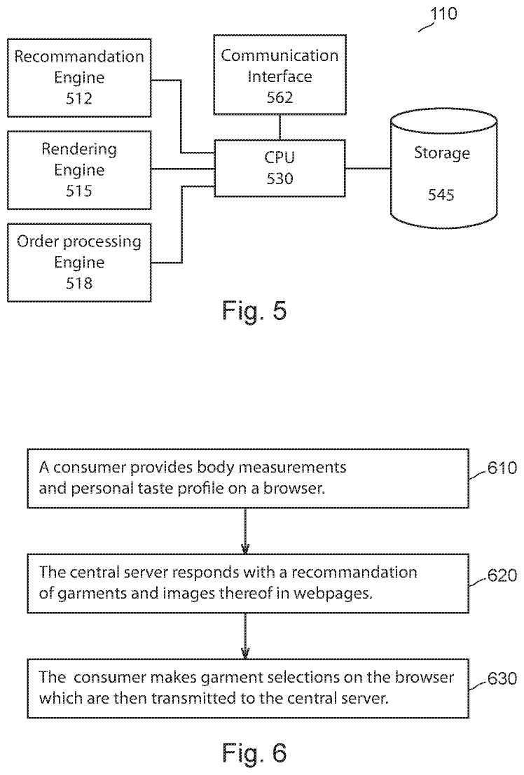

FIG. 5 illustrates an exemplary central server 110 according to an embodiment of the present disclosure. The central server 110 hosts the CGCA which includes a recommendation engine 512, a rendering engine 515 and an order processing engine 518 run on a CPU 530 and a storage 545. The central server 110 communicates with the various terminals through a communication interface 562 over the Internet. In embodiments, the CGCA may be deployed over a cloud computing platform such as Amazon Web Services or Microsoft Azure, thus the central server 110 is part of the cloud computing platform. In operation the CGCA generates webpages in response to requests from the various terminals, and then transmits the webpages to the requesting terminals for being displayed on respective browsers. The webpages serve to carry information to the terminals and receive information entered at the terminals and send them back to the CGCA.

Referring again to FIG. 5, after receiving a consumer's taste profile and body measurements, the recommendation engine 512 may use predetermined criteria to generate some fashion recommendations for the consumer. The recommendation is then used to select existing designs stored in the storage 545. The selected designs are then provided to the rendering engine 515 which will fit the selected designs to the body measurements and generates images of a virtual model donning the selected designs. The images are then sent to the corresponding consumer terminal 120 for being displayed on the browser.

Referring again to FIG. 5, the order processing engine 518 combines garment orders from different consumers that share the same feature, such as a fabric or a category. When an order message arrives at the central server 110, the CGCA parses the order message and extract feature information, such as fabric and category, of the ordered garment. The CGCA does not send the order to a fabric supplier's terminal 140 right away, instead it waits for a predetermined time, combines all the orders using the same fabric received during this time, and at an end of the time, sends the combined order to a vender of the fabric. In an embodiment, the predetermined time may be 24 hours. Similarly, the CGCA waits for another predetermined time, combines all the orders that shares the same garment category, such as T-shirt, and then sends the combined order to a sewer's terminal 150 relating to a sewer specialized in that garment category. In this case, different fabrics may come from different vendors, but they all send the cut fabrics to the same sewer's terminal 150 designated by the CGCA.

FIG. 6 is a flowchart illustrating a garment ordering process according to an embodiment of the present disclosure. The garment ordering process begin with a consumer accessing the CGCA run on the central server 110 through a remote consumer's terminal computer 120. For instance, when the consumer enters a web address, e.g., http://garmentapp.com, on the consumer's terminal computer 120, a home page will then be served on the consumer's browser. From the home page the consumer can interact with the CGCA in various pre-defined ways.

In step 610, the consumer provides body measurements and a personal taste profile on webpages presented on a browser at the consumer's computer terminal 120. The body measurements and the personal taste profile are then transmitted to the CGCA run on the central server 110. In embodiments, information transmitted between the central servers 110 and the various terminals 120-150 are in JavaScript Object Notation (JSON) format.

In step 620, the CGCA run on the central server 110 parses the information from the consumer's computer terminal and responds with a commendation of garments and images thereof in webpages that are sent to the consumer's computer terminal 120. In embodiments, the CGCA simply provides a list of garment images in webpages for the consumer.

In step 630, the consumer makes garment selections on the webpages in the browser which then transmits the selections as orders to the CGCA on the central server 110.

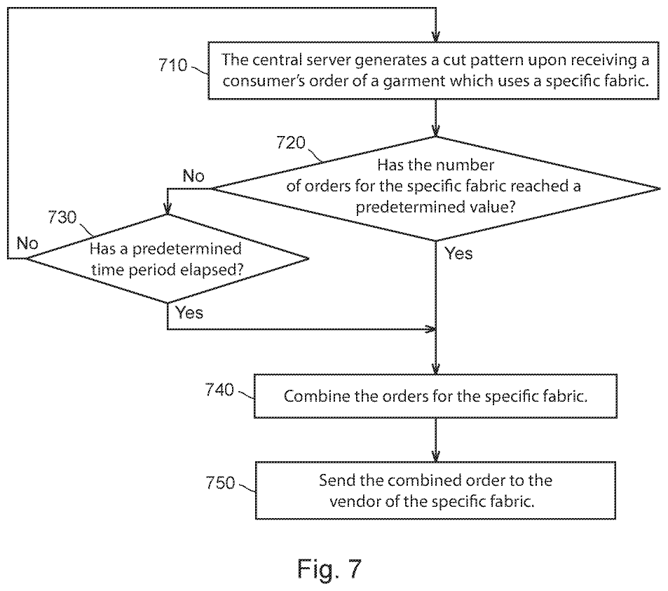

FIG. 7 is a flowchart illustrating an order processing procedure by the CGCA on the central server 110. The order processing procedure involves step 710 in which the CGCA on the central server 110 generates a cut pattern upon receiving a consumer's order of a garment which uses a specific fabric. The cut pattern is generated based on this particular consumer's body measurements stored in a consumer profile database. Alternatively, the cut pattern may be generated by a garment designer on a designer's terminal computer 130 after the designer acquires the consumer's body measurement from the central server 110. The cut pattern is then sent to the central server 110 for storage and for further processing.

In step 720, the CGCA on the central server 110 checks if the number of orders for the specific fabric has reached a predetermined value. If the number has reached the predetermined value, the CGCA combines the orders for the specific fabric in step 740 and send the combined order to a vendor of the specific fabric for cutting in step 750. The vender information for all the fabrics are stored in a fabric database accessible by the CGCA. A fabric vender can enter the fabric information into the fabric database through the fabric supplier's terminal computer 140. On the other hand, if the number has not reached the predetermined value, the CGCA further checks in step 730 if a predetermined time since the first order has entered has elapsed. If the checking result is “yes”, the procedure will proceed to step 740 and combines whatever number of orders received. If the checking result is “no”, the procedure will wait for more orders and return to step 710. In an embodiment, the predetermined value for the number of orders is 2, while the predetermined time is 24 hours for timely filling a consumer's order.

Although the disclosure is illustrated and described herein as embodied in one or more specific examples, it is nevertheless not intended to be limited to the details shown, since various modifications and structural changes may be made therein without departing from the spirit of the disclosure and within the scope and range of equivalents of the claims. Accordingly, it is appropriate that the appended claims be construed broadly and in a manner consistent with the scope of the disclosure, as set forth in the following claims.

What is claimed is:

1. A computer-implemented method for creating customized garments comprising executing on a processor the steps of:
generating a first cut pattern upon receiving a first electronic communication from a first remote computer identifying a first garment design of a first category using a first fabric;
generating a second cut pattern upon receiving a second electronic communication from a second remote computer identifying a second garment design of a second category also using the first fabric;
identifying a supplier of the first fabric by searching in a fabric database using a code of the first fabric; and
sending electronic communications containing the first and the second cut pattern to a third remote computer relating to the identified supplier of the first fabric.

2. The computer-implemented method of claim 1, wherein the first and the second remote computer relate to different consumers.

3. The computer-implemented method of claim 1, wherein the first and the second garment design are different.

4. The computer-implemented method of claim 1, wherein the first and the second garment design are the same.

5. The computer-implemented method of claim 1, wherein the first and the second category are the same.

6. The computer-implemented method of claim 1, wherein the first and the second electronic communication are HyperText Transfer Protocol (HTTP) messages.

7. The computer-implemented method of claim 1 further comprising:
before receiving the first electric communication, receiving a first set of body measurements in an electronic communication from the first remote computer;
rendering the first garment design from a first base design using the first set of body measurements;
generating a web page illustrating the first garment design; and
transmitting the web page to the first remote computer.

8. The computer-implemented method of claim 7, wherein the first base design is received from a fourth remote computer and stored in a design database.

9. The computer-implemented method of claim 8, wherein the fourth remote computer relates to a fashion designer.

10. The computer-implemented method of claim 8 further comprising:
before receiving the first base design, retrieving information of the first fabric from the fabric database in response to a request from the fourth remote computer; and
sending the information of the first fabric in a web page to the fourth remote computer.

11. The computer-implemented method of claim 1 further comprising:
generating a third cut pattern upon receiving an electronic communication identifying a garment design of the first category using a second fabric;
identifying a supplier of the second fabric by searching in the fabric database using a code of the second fabric;
identifying a sewer specialized in the first category of garment design in a sewer database;
sending an electronic communication to a remote computer relating to the identified supplier of the second fabric containing the third cut pattern along with an instruction to send a cut second fabric according to the third cut pattern to the identified sewer; and
sending an electronic communication to the third remote computer with an instruction to send a cut first fabric according to the first cut pattern also to the identified sewer.
